(19) United States
(12) Patent Application Publication
(10) Pub. No.: US 2026/0104817 A1
(43) Pub. Date: Apr. 16, 2026

(54) RANDOM WRITE INSTRUCTION PROCESSING METHOD, SMR HARD DISK, AND COMPUTER DEVICE

(71) Applicant: SUZHOU METABRAIN INTELLIGENT TECHNOLOGY CO., LTD., Suzhou, Jiangsu (CN)

(72) Inventor: Daigang WANG, Suzhou, Jiangsu (CN)

(21) Appl. No.: 19/115,715

(22) PCT Filed: Feb. 27, 2024
(86) PCT No.: PCT/CN2024/078846

§ 371 Date: Mar. 26, 2025

(30) Foreign Application Priority Data
Apr. 3, 2023 (CN) 202310346343.2

(51) Int. Cl. G06F 3/06

(52) U.S. Cl. CPC G06F 3/0655; G06F 3/0604; G06F 3/0676

(57) ABSTRACT

The present application relates to a random write instruction processing method, an SMR hard disk, and a computer device, and is applied to a main controller in the SMR hard disk. The SMR hard disk further includes a storage class memory SCM and a disk. The method includes: in response to receiving a random write instruction and random write data sent by a host device, performing a data buffering operation and a data integration operation in the SCM; and when the disk is subjected to track rewriting, caching track rewriting temporary data to the SCM.

### CROSS-REFERENCE TO RELATED APPLICATION

The present application claims priority to Chinese patent application No. 202310346343.2, entitled “RANDOM WRITE INSTRUCTION PROCESSING METHOD, SMR HARD DISK, AND COMPUTER DEVICE”, filed on Apr. 3, 2023 before the China National Intellectual Property Administration, which is incorporated herein in its entirety by reference.

### TECHNICAL FIELD

Embodiments of the present application relate to the field of storage technology, and in particular, to a random write instruction processing method, a shingled magnetic recording (SMR) hard disk, and a computer device.

### BACKGROUND

With the rise of the big data era, the application volume of data has shown exponential growth. As mechanical hard drives remain the mainstay of data storage, hard drive manufacturers have introduced SMR mechanical hard drives to meet the increasing demand for data storage. Compared to traditional conventional magnetic recording (CMR) hard drives, SMR hard drives offer the advantages of higher data density and lower cost for the same capacity.

### SUMMARY

A first aspect of the present application provides a random write instruction processing method, applied to a main controller in a SMR hard drive. The SMR hard drive further includes a storage class memory (SCM) and a platter. The method includes:
in response to receiving a random write instruction and random write data sent from a host device, performing a data buffering operation and a data integration operation in the SCM, and caching track rewriting temporary data to the SCM when performing track rewriting on the platter.

In some embodiments, the data buffering operation is used for organizing the random write data into sequential write data; the data integration operation is used for integrating original track data retrieved from the platter according to the random write instruction with new data corresponding to the data integration operation to form new track data.

In some embodiments, the method further includes:
monitoring occupied capacity of the SCM;
in response to the occupied capacity of the SCM being not less than a first capacity threshold, detecting whether a temporary memory cache area is provided in a memory of the host device, the first capacity threshold being less than a total storage capacity of the SCM; and
in response to detecting that no temporary memory cache area is provided in the memory of the host device, requesting an idle memory space from the host device to be used as the temporary memory cache area.

In some embodiments, the method further includes:
in response to the occupied capacity of the SCM being less than the first capacity threshold, performing a data buffering operation and a data integration operation in the SCM, and when performing track rewriting on the platter, caching track rewriting temporary data to the SCM.

In some embodiments, after requesting the idle memory space from the host device to be used as the temporary memory cache area, the method further includes:
in response to receiving a new random write instruction sent from the host device and the current occupied capacity of the SCM being not less than the first capacity threshold, instructing the host device to write the random write data associated with the random write instruction in the memory of the host device to the temporary memory cache area; and
performing the data buffering operation and the data integration operation in the temporary memory cache area, and caching the track rewriting temporary data to the temporary memory cache area when performing track rewriting on the platter.

In some embodiments, the method further includes:
writing data in the temporary memory cache area required to be written to the platter to the platter through an available storage space in the SCM.

In some embodiments, the method further includes:
writing the original track data retrieved from the platter according to the random write instruction to the temporary memory cache area through the available storage space in the SCM.

In some embodiments, the platter includes a hard drive temporary cache area, the method further includes:
monitoring the occupied capacity of the temporary memory cache area; and
in response to receiving a new random write instruction and random write data sent from the host device and the current occupied capacity of the temporary memory cache area being not less than a second capacity threshold, performing the data buffering operation and the data integration operation in the hard drive temporary cache area, wherein the second capacity threshold is not greater than the total storage capacity of the temporary memory cache area.

In some embodiments, after performing the data buffering operation and the data integration operation in the hard drive temporary cache area, the method further includes:
when performing track rewriting on the platter, caching the track rewriting temporary data to the hard drive temporary cache area, and writing data in the hard drive temporary cache area required to be written to the platter to the platter.

In some embodiments, the method further includes
in response to receiving a new random write instruction and random write data sent from the host device and the current occupied capacity of the temporary memory cache area being less than the second capacity threshold, instructing the host device to write the random write data associated with the random write instruction in the memory of the host device to the temporary memory cache area;
performing the data buffering operation and the data integration operation in the temporary memory cache area, and caching the track rewriting temporary data to the temporary memory cache area when performing track rewriting on the platter; and
writing the data in the temporary memory cache area required to be written to the platter to the platter through the available storage space in the SCM.

In some embodiments, the requesting an idle memory space from the host device to be used as a temporary memory cache area includes:
requesting memory usage information from the host device;
determining whether a preset application condition is met based on the memory usage information; and
in response to the preset application condition being met, requesting the idle memory space from the host device to be used as the temporary memory cache area.

In some embodiments, the method further includes:
after requesting the idle memory space from the host device to be used as the temporary memory cache area, timing a duration for which the occupied capacity of the SCM is less than the first capacity threshold, and in response to the timed duration exceeding a preset duration threshold, releasing the temporary memory cache area.

In some embodiments, the method further includes
requesting memory usage information from the host device, determining whether a preset release condition is met based on the memory usage information, and in response to the preset release condition being met, releasing the temporary memory cache area.

In some embodiments, the platter includes a hard drive temporary cache area, the method further includes:
monitoring the occupied capacity of the SCM;
in response to receiving a new random write instruction and random write data sent from the host device and the current occupied capacity of the SCM being not less than a third preset capacity threshold, performing the data buffering operation and the data integration operation in the hard drive temporary cache area, wherein the third preset capacity threshold is less than the total storage capacity of the SCM; and
when performing track rewriting on the platter, caching the track rewriting temporary data to the hard drive temporary cache area, and writing the data in the hard drive temporary cache area required to be written to the platter to the platter.

In some embodiments, the method further includes:
in response to the current occupied capacity of the SCM being less than the third preset capacity threshold; and
performing the data buffering operation and the data integration operation in the SCM.

Another aspect of the present application provides a random write instruction processing device, located in a shingled magnetic recording (SMR) hard drive that further includes a storage class memory (SCM) and a platter, the random write instruction processing device includes:
a first module, configured to perform a data buffering operation and a data integration operation in the SCM in response to receiving a random write instruction and random write data sent from a host device; and
a second module, configured to cache track rewriting temporary data to the SCM when performing track rewriting on the platter.

Another aspect of the present application further provides a shingled magnetic recording (SMR) hard drive, including a main controller, a storage class memory (SCM), and a platter.

In some embodiments, the SCM includes a first firmware storage area for storing host memory borrowing firmware. In some embodiments, the SCM includes a second firmware storage area for storing BIOS that is a basic input/output system.

Another aspect of the present application further provides a computer device including a host device and the SMR hard drive described above.

### BRIEF DESCRIPTION OF THE DRAWINGS

FIG. 1 is a schematic diagram of a random write instruction processing method of one or more embodiments of the present application;

FIG. 2 is a schematic diagram of data interaction in an SMR hard drive of one or more embodiments of the present application;

FIG. 3 is a schematic diagram of a method for applying for a temporary memory buffer from a host in one or more embodiments of the present application;

FIG. 4 is a schematic diagram of a random write instruction processing method in an SCM+temporary memory buffer mode in one or more embodiments of the present application;

FIG. 5 is a schematic diagram of a random write instruction processing method in an SCM+MC+temporary memory buffer mode in one or more embodiments of the present application;

FIG. 6 is a schematic diagram of a host memory borrowing method in one or more embodiments of the present application;

FIG. 7 is a schematic diagram of a method for releasing the temporary memory buffer based on the SCM occupied capacity in one or more embodiments of the present application;

FIG. 8 is a schematic diagram of a method for releasing the temporary memory buffer based on usage information of the memory of the host in one or more embodiments of the present application;

FIG. 9 is a schematic diagram of a random write instruction processing method in an SCM+MC mode in one or more embodiments of the present application;

FIG. 10 is a schematic diagram of a random write instruction processing device in one or more embodiments of the present application;

FIG. 11 is a schematic diagram of data interaction between an SMR hard drive and a host in one or more embodiments of the present application;

FIG. 12 is a schematic diagram of an SMR hard drive structure in one or more embodiments of the present application; and

FIG. 13 is a schematic diagram of a host device in one or more embodiments of the present application.

### DETAILED DESCRIPTION OF THE EMBODIMENTS

In order to make the objectives, technical solutions, and advantages of this application clearer, the following further describes this application in detail with reference to the accompanying drawings and embodiments. It should be understood that the specific embodiments described here are used to explain the present application and are not intended to limit the present application.

Due to the inherent design flaws of SMR, when data on a track needs to be rewritten, the data from the next track must be prefetched and temporarily stored in the cache first. Then, the current track is rewritten, but the same issue arises when writing back the data from the next track. This makes the random rewrite process of SMR hard drives extremely complex and requires more cache usage. In scenarios with frequent random writes, the cache can easily be exhausted, leading to severe performance degradation of the hard drive. To address this issue, hard drive manufacturers not only continuously optimize the data read/write and management mechanisms but also increase the cache size at the manufacturing level. However, this introduces other problems such as a higher risk of data loss after power failure and increased hard drive costs.

In existing solutions, the overlapping tracks of SMR hard drives are typically divided into multiple SMR Bands (Shingled Magnetic Recording Bands) to address the above issues. Among these, non-overlapping regions exist between the Bands, so that rewriting data only requires reading and overwriting the content of one Band at most, thereby improving random write performance. Alternatively, large-capacity dynamic random access memory (DRAM) chips are used to cache random write data and temporarily offloaded data during track rewriting, enabling quick overwriting and enhancing random write performance. Another approach is to allocate a few GB or tens of GB of space on the hard drive platter as an MC (Media Cache) area to further cache random write data that cannot be stored in DRAM, effectively serving as a secondary cache in addition to DRAM. During idle times, the data in the platter cache can be gradually relocated.

However, the inventors have realized that dividing the overlapping tracks of SMR hard drives into multiple SMR Bands provides limited improvement in random write performance. Additionally, using large-capacity DRAM chips as cache introduces the risk of data loss during power outages and is constrained by DRAM capacity and cost. While the use of MC can somewhat mitigate the drawbacks of SMR hard drives, it also occupies part of the user area of the hard drive and has slower cache speeds.

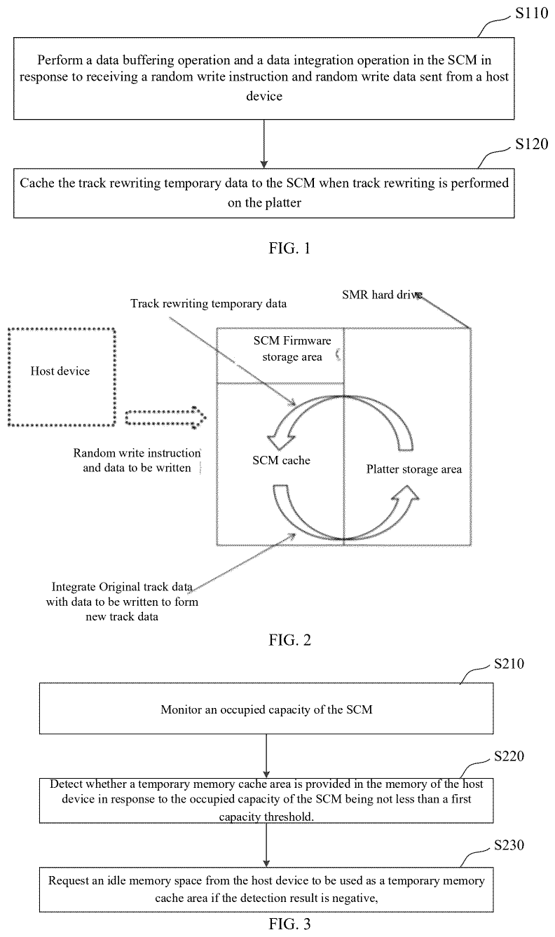

A first aspect of the present application provides a random write instruction processing method, applied to a main controller in an SMR hard drive. The SMR hard drive also includes SCM (Storage Class Memory) and a platter. As shown in FIG. 1, the method includes:

At S110, in response to receiving a random write instruction and random write data sent from a host device, a data buffering operation and a data integration operation are performed in the SCM.

Specifically, the random write instruction is a computer instruction sent from the host device to the SMR hard drive. After receiving the random write command, the main controller of the SMR hard drive needs to write the random write data to a track specified by the random write instruction on the platter. To write this random write data to the track, the main controller needs to perform a data buffering operation and a data integration operation in the SCM. The data buffering operation is used for organizing the random write data into sequential write data; the data integration operation is used for integrating original track data, which is retrieved from the platter by the main controller according to the random write instruction, with new data corresponding to the data integration operation to form new track data. Here, the new data corresponding to the data integration operation is the sequential write data corresponding to the random rewrite command.

At S120, when track rewriting is performed on the platter, the track rewriting temporary data is cached to the SCM.

Specifically, when data on a certain track is rewritten in the platter, in addition to retrieving the data on that track to the SCM for data integration, the data on the next track in the same sector must be prefetched and temporarily stored in the SCM first so as to avoid affecting the data on the next track. After writing the integrated data to the current track, the data from the next track stored in the SCM is written back to the next track. When writing the data back to the next track, to avoid affecting the data on the subsequent track, the above operations must be repeated, i.e., the data on the subsequent track is fetched to the SCM for caching. After completing the data writing for the next track, the data on the subsequent track is written back. The data on the next track is the track rewriting temporary data. For example, as shown in FIG. 2, a platter is stored in the platter storage area of the SMR hard drive. The SCM is divided into a cache area. The SCM is a type of memory with high-speed read/write characteristics and non-volatility. The types of SCM media include but are not limited to PCM (Phase-change memory), ReRAM (Resistive random-access memory), MRAM (Magnetic Random Access Memory), and NRAM (Nantero's CNT Random Access Memory).

Moreover, the maximum storage capacity of commercially available SCMs can reach 64 GB, and theoretically, it can be as high as several hundred GB. It is evident that the storage capacity of SCMs far exceeds that of DRAMs (typically 1-16 GB). Therefore, the mode of using the SCM as the cache area of the SMR hard drive in this application has more advantages compared to the current DRAM+MC cache mode. It can address the severe performance degradation issue of SMR hard drives when facing a large number of random write I/Os. Additionally, the SCM has non-volatile characteristics, allowing it to preserve cached data not yet written to the hard drive in the event of an abnormal power failure, thereby avoiding the risk of data loss.

In some embodiments, as shown in FIG. 3, the method further includes:

At S210, an occupied capacity of the SCM is monitored.

Specifically, when data rewriting is performed on tracks of the platter, the data on the tracks must be prefetched and temporarily stored in the SCM first, and the data occupies the storage capacity of the SCM. The main controller monitors the occupied capacity of the SCM in real time, where the occupied capacity represents the real-time occupancy rate of the total storage capacity of the SCM.

For example, the occupied capacity of the SCM is 80% of its total storage capacity.

At S220, in response to the occupied capacity of the SCM being not less than a first capacity threshold, it is detected whether a temporary memory cache area is provided in the memory of the host device. The first capacity threshold is less than the total storage capacity of the SCM.

Specifically, the first capacity threshold is a specific occupancy rate of the total storage capacity of the SCM, which can be set according to actual conditions. This embodiment does not impose specific limitations. The temporary memory cache area is a part of the memory space of the host device, used to store overflow cache from the SCM.

In some embodiments, when the occupied capacity of the SCM is less than the first capacity threshold, the data buffering operation and the data integration operation are performed in the SCM, and when the track rewriting is performed on the platter, the track rewriting temporary data is cached to the SCM. Specifically, when the occupied capacity of the SCM is less than the first capacity threshold, it indicates that there is a free space in the SCM, and the data on the track will be entirely prefetched to the SCM by the main controller. The main controller does not need to request an idle memory space from the host device. The first capacity threshold can be set and adjusted according to specific scenarios. For example, the first capacity threshold is set to 70% of the total storage capacity of the SCM.

At S230, if the detection result is negative, an idle memory space is requested from the host device to be used as a temporary memory cache area.

Specifically, if there in no temporary memory cache area in the memory of the host device, the main controller will request an idle memory space from the host device and virtualize this space as the cache of the SMR hard drive, i.e., the temporary memory cache area. The idle memory space is a part of the idle storage space in the memory of the host device. After virtualizing the idle memory space in the host device's memory as the temporary memory cache area, the temporary memory cache area becomes part of the cache space of the SCM.

The method for requesting an idle memory space from the host device to be used as a temporary memory cache area includes: requesting memory usage information from the host device and determining whether a preset application condition is met based on the memory usage information. When the preset application condition is met, an idle memory space is requested from the host device and used as the temporary memory cache area.

Specifically, the memory usage information can be the real-time occupancy rate of the memory space of the host device, and the preset application condition can be a specific real-time occupancy rate of the memory space, which can be set according to actual needs. This application does not impose limitations. For example, when the real-time occupancy rate of the memory space of the host device does not exceed a specific real-time occupancy rate, it is considered that the preset application condition is met, and the idle memory space is requested from the host device and used as the temporary memory cache area.

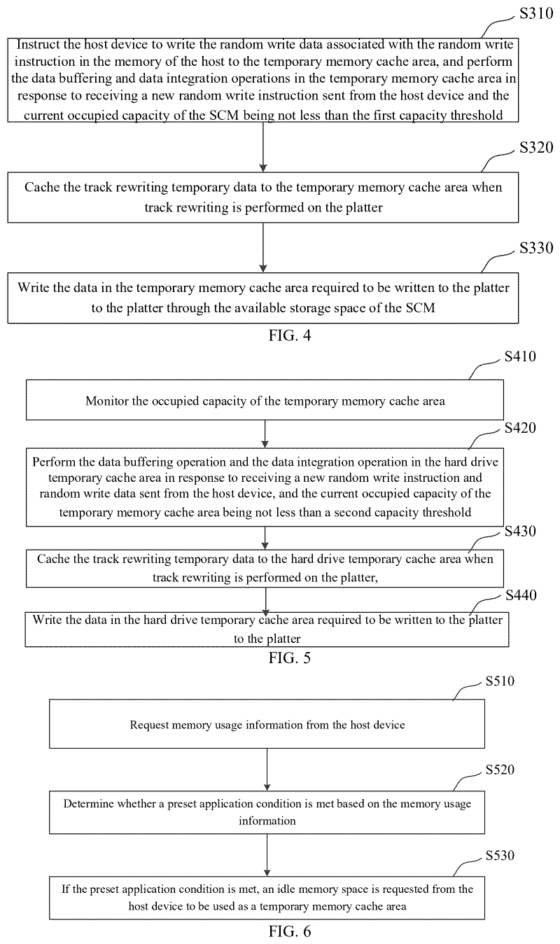

As shown in FIG. 4, the method further includes:

At S310, in response to receiving a new random write instruction sent from the host device and the current occupied capacity of the SCM being not less than the first capacity threshold, the host device is instructed to write the random write data associated with the random write instruction in the memory of the host to the temporary memory cache area, and the data buffering operation and the data integration operation are performed in the temporary memory cache area.

Specifically, after requesting an idle memory space from the host device to be used as a temporary memory cache area, the new random write instruction sent from the host device is a random write instruction sent from the host device to the SMR hard drive. When the host memory (i.e., the memory of the host device) has a temporary memory cache area with free storage space, the host device can send only the random write instruction to the main controller, and write the random write data, which would otherwise be sent to the main controller, to the temporary memory cache area directly. After receiving the random write command, the main controller can directly operate on the random write data associated with the random write instruction stored in the temporary memory cache area.

In some embodiments, the method further includes:
writing the data in the temporary memory cache area required to be written to the platter to the platter through the available storage space of the SCM. Here, the sum of the available storage space and the used storage space of the SCM is the total storage capacity of the SCM. The original track data retrieved from the platter according to the random write instruction is written to the temporary memory cache area through the available storage space of the SCM.

Specifically, the main controller temporarily stores the original track data retrieved from the platter in the available storage space of the SCM, and then writes the original track data temporarily stored in the available storage space to the temporary memory cache area.

At S320, when track rewriting is performed on the platter, the track rewriting temporary data is cached to the temporary memory cache area.

Specifically, since the temporary memory cache area has become part of the cache space of the SCM, when rewriting data on a track of the platter, the data on the track will be prefetched and temporarily stored in the temporary memory cache area.

In some embodiments, when the occupied capacity of the SCM is less than the first capacity threshold, the data buffering operation and the data integration operation are performed in the SCM, and when track rewriting is performed on the platter, the track rewriting temporary data is cached to the SCM.

Specifically, when the main controller detects that the occupied capacity of the SCM is less than the first capacity threshold, it indicates that there is free space in the used storage space of the SCM, and there is no need to prefetch the data on the track to the temporary memory cache area for temporary storage.

At S330, the data in the temporary memory cache area required to be written to the platter is written to the platter through the available storage space of the SCM.

Specifically, the available storage space of the SCM is served as a data channel for the main controller to write the data in the temporary memory cache area required to be written to the platter. That is, the main controller first transfers the data in the temporary memory cache area to the available storage space of the SCM, and then writes the data from the available storage space of the SCM to the platter. Moreover, the sum of the capacity of the available storage space of the SCM and the occupied capacity of the SCM equals the total storage capacity of the SCM. For example, if the occupied capacity of the SCM is 70% of the total storage capacity, the capacity of the available storage space of the SCM is 30% of the total storage capacity. This 30% of the total storage capacity will be served as a data channel for the main controller to write the data in the temporary memory cache area required to be written to the platter.

For example, as shown in FIG. 2, the platter storage area is equipped with the platter, and the firmware storage area is stored with the host memory borrowing firmware. Through the above method, real-time monitoring of the occupied capacity of the SCM can be achieved to prevent overflow of the SCM cache area. Additionally, the host memory borrowing firmware is used to request a temporary memory cache area from the host memory, expanding the storage capacity of the SCM cache area.

In some embodiments, the platter includes a hard drive temporary cache area. As shown in FIG. 5, the method further includes:

At S410, the occupied capacity of the temporary memory cache area is monitored.

Specifically, the temporary memory cache area is a part of the cache space in the host device's memory. Overflow data from the SCM will be stored in the temporary memory cache area, and this overflow data will occupy the storage capacity of the temporary memory cache area. The main controller will monitor the occupied capacity of the temporary memory cache area in real time, where the occupied capacity represents the real-time occupancy rate of the total storage capacity of the temporary memory cache area. For example, the occupied capacity of the temporary memory cache area is 80% of its total storage capacity.

At S420, in response to receiving a new random write instruction and random write data sent from the host device, and the current occupied capacity of the temporary memory cache area being not less than a second capacity threshold, the data buffering operation and the data integration operation are performed in the hard drive temporary cache area. The second capacity threshold is not greater than the total storage capacity of the temporary memory cache area.

Specifically, after requesting an idle memory space from the host device to be used as a temporary memory cache area, the new random write instruction sent from the host device is a random write instruction sent from the host device to the SMR hard drive. The second capacity threshold is a specific occupancy rate of the total storage capacity of the temporary memory cache area, which can be set according to actual conditions. This embodiment does not impose specific limitations. Alternatively, when the occupied capacity of the temporary memory cache area is less than the second capacity threshold, the aforementioned overflow data will not be sent to the hard drive temporary cache area but will instead perform a data buffering operation and a data integration operation in the temporary memory cache area and the SCM cache area. The second capacity threshold can be set and adjusted according to specific scenarios. For example, the second capacity threshold is set to 70% of the total storage capacity of the temporary memory cache area.

In some embodiments, when receiving the new random write instruction sent from the host device and the current occupied capacity of the temporary memory cache area is less than the second capacity threshold, the host device is instructed to write the random write data associated with the random write instruction from the host memory to the temporary memory cache area; perform the data buffering operation and the data integration operation in the temporary memory cache area, and when performing track rewriting on the platter, cache the track rewriting temporary data to the temporary memory cache area, and write the data in the temporary memory cache area required to be written to the platter to the platter through the available storage space of the SCM.

Specifically, when the current occupied capacity of the temporary memory cache area is less than the second capacity threshold, it indicates that there is free space in the temporary memory cache area, and the main controller can normally write the random write data to the temporary memory cache area.

At S430, when track rewriting is performed on the platter, the track rewriting temporary data is cached to the hard drive temporary cache area.

Specifically, since the hard drive temporary cache area is served as an independent extended cache area separate from the SCM, when rewriting data on a track of the platter, the data on the track will be prefetched and temporarily stored in the hard drive temporary cache area. The data on the track is the track rewriting temporary data.

At S440, the data in the hard drive temporary cache area required to be written to the platter is written to the platter.

Through the above method, real-time monitoring of the occupied capacity of the SCM+temporary memory cache area can be achieved to prevent overflow of the SCM cache area. Additionally, the cache mode of SCM+temporary memory cache area+MC area is adopted, further expanding the storage capacity of the SCM cache area.

In some embodiments, as shown in FIG. 6, the requesting an idle memory space from the host device to be used as a temporary memory cache area includes steps described below.

At S510, memory usage information is requested from the host device.

Specifically, the main controller sends a request to the host device while executing the host memory borrowing firmware to obtain the memory usage information of the host device. The memory usage information reflects the occupancy rate of the host memory space, indicating whether the host device has idle memory space. Specifically, the host memory borrowing mechanism involves the main controller requesting part of the host memory space from the host device to be used as the cache for the SMR hard drive, further expanding the cache space available to the SMR hard drive. When a large number of random write I/Os (Input/Output) in a short period cause the cache space of the SCM hard drive to be nearly exhausted, the host memory borrowing mechanism is activated, and part of the host memory space is requested as a new cache for random write I/Os.

At S520, it is determined whether a preset application condition is met based on the memory usage information.

The preset application condition can be set according to actual conditions. For example, the preset application condition is: “the occupancy rate of the host memory space is not greater than 50%.”

At S530, if the preset application condition is met, an idle memory space is requested from the host device to be used as a temporary memory cache area.

For example, when the host memory space occupancy rate is 40%, it satisfies the preset application condition “the occupancy rate of the host memory space is not greater than 50%,” and the main controller requests an idle memory space from the host device to be used as a temporary memory cache area. Through the above method, temporary borrowing of host memory is achieved, and the host memory borrowing firmware is used to request a temporary memory cache area from the host memory, expanding the storage capacity of the SCM cache area. Specifically, the main controller commands the SMR hard drive to communicate with the host device through the host memory borrowing firmware. Since the host device itself has memory occupancy rate information, the main controller can request the host device to return the memory occupancy rate information for judgment. The implementation of this judgment is based on communication between the main controller of the SMR hard drive and the host device, and corresponding firmware is developed within the hard drive for judgment. Therefore, other implementation schemes different from the above are also possible. The premise of borrowing host memory is not to affect the operation of the host device, so a threshold needs to be set here. When it is determined that the host memory occupancy reaches a certain level, or the remaining host memory space is below a certain capacity, the main controller stops requesting host memory borrowing.

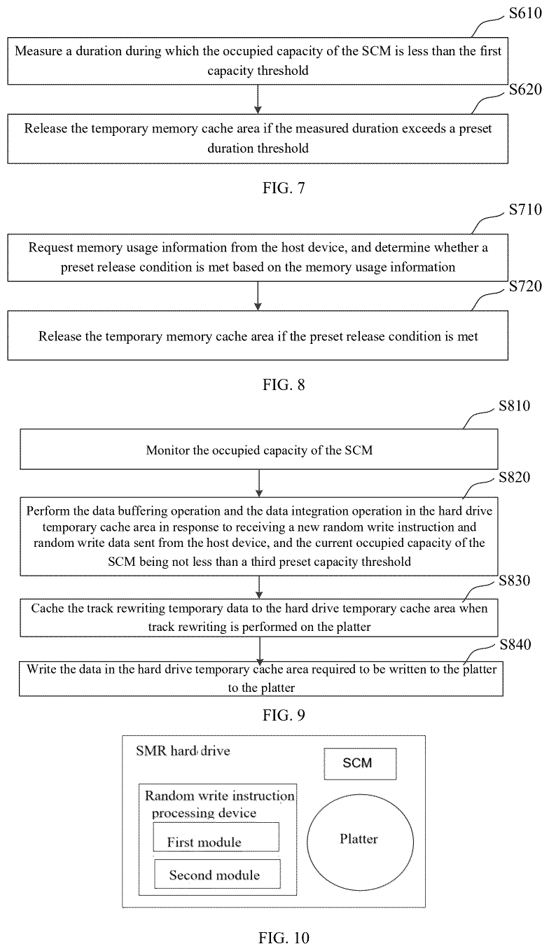

In some embodiments, as shown in FIG. 7 and FIG. 8, after requesting an idle memory space from the host device to be used as a temporary memory cache area, the method further includes steps described below.

At S610, a duration during which the occupied capacity of the SCM is less than the first capacity threshold is measured.

Specifically, the occupied capacity represents the real-time occupancy rate of the total storage capacity of the temporary memory cache area. The first capacity threshold is a specific occupancy rate of the total storage capacity of the SCM. For example, when the occupied capacity of the temporary memory cache area is 70% of the total storage capacity and the first capacity threshold is set to 80% of the total storage capacity of the SCM, timing begins for the duration that the occupied capacity is less than the first capacity threshold.

At S620, If the measured duration exceeds a preset duration threshold, the temporary memory cache area is released.

For example, if the measured duration is 2 milliseconds and the preset duration threshold is 1 millisecond, the measured duration exceeds the preset duration threshold, and the temporary memory cache area is released to reduce the occupation time of the host memory and avoid long-term occupation of the host memory.

At S710, memory usage information is requested from the host device, and it is determined whether a preset release condition is met based on the memory usage information.

Specifically, the memory usage information reflects the occupancy rate of the host memory space, indicating whether the host device has an idle memory space. The preset release condition can be set according to actual conditions, and this embodiment does not impose specific limitations.

For example, the preset release condition is: “the occupancy rate of the host memory space is less than 50%.” The main controller determines whether to release the temporary memory cache area based on the above preset release condition.

At S720, if the preset release condition is met, the temporary memory cache area is released.

For example, when the occupancy rate of the host memory space is 40%, satisfying the release condition, the temporary memory cache area is released to avoid excessive occupation of the host memory.

In some embodiments, the platter includes a hard drive temporary cache area. The storage space of the hard drive temporary cache area can be set according to specific conditions, and this embodiment does not impose specific limitations. For example, a few GB or tens of GB of space can be allocated from the platter as the hard drive temporary cache area. The method further includes steps described below.

At S810, the occupied capacity of the SCM is monitored.

At S820, in response to receiving a new random write instruction and random write data sent from the host device, and the current occupied capacity of the SCM being not less than a third preset capacity threshold, the data buffering operation and the data integration operation are performed in the hard drive temporary cache area; the third preset capacity threshold is less than the total storage capacity of the SCM.

Specifically, the third preset capacity threshold is a specific occupancy rate of the total storage capacity of the SCM, which can be set according to actual conditions. This embodiment does not impose specific limitations. Alternatively, when the current occupied capacity of the SCM is less than the third preset capacity threshold, SCM data will not overflow, and a data buffering operation and a data integration operation will only be performed in the SCM cache area. The third preset capacity threshold can be set and adjusted according to specific scenarios. For example, the third preset capacity threshold is set to 80% of the total storage capacity of the SCM.

At S830, when track rewriting is performed on the platter, the track rewriting temporary data is cached to the hard drive temporary cache area.

Specifically, since the hard drive temporary cache area is also served as part of the cache space of the SCM, when rewriting data on a track of the platter, the data on the track will be prefetched and temporarily stored in the hard drive temporary cache area. The data on the track is the track rewriting temporary data.

At S840, the data in the hard drive temporary cache area required to be written to the platter is written to the platter.

Through the above method, real-time monitoring of the occupied capacity of the SCM area can be achieved, and the MC area can be promptly invoked to handle overflow data from the SCM. Additionally, the cache mode of SCM+MC area is adopted, further expanding the storage capacity of the SCM cache area.

According to another aspect, this application also provides a random write instruction processing device, as shown in FIG. 10. The device is located in an SMR hard drive, which also includes a storage class memory (SCM) and a platter. The device includes:
a first module, configured to perform a data buffering operation and a data integration operation in the SCM in response to receiving a random write instruction and random write data sent from a host device; and
a second module, configured to cache track rewriting temporary data to the SCM when performing track rewriting on the platter.

In some embodiments, the device further includes a third module, which is configured to monitor the occupied capacity of the SCM. If the occupied capacity of the SCM is not less than a first capacity threshold, the third module checks whether a temporary memory cache area is provided in the memory of the host device. If the detection result is negative, the third module requests an idle memory space from the host device to be used as a temporary memory cache area.

In some embodiments, the first module is further configured to: perform the data buffering operation and the data integration operation in the SCM when the occupied capacity of the SCM is less than the first capacity threshold. Correspondingly, the second module is also configured to cache track rewriting temporary data to the SCM when performing track rewriting on the platter.

In some embodiments, the first module is further configured to: when receiving a new random write instruction sent from the host device and the current occupied capacity of the SCM is not less than the first capacity threshold, instruct the host device to write the random write data associated with the random write instruction in the host memory to the temporary memory cache area; perform the data buffering operation and the data integration operation in the temporary memory cache area. Correspondingly, the second module is also configured to cache track rewriting temporary data to the temporary memory cache area when performing track rewriting on the platter.

In some embodiments, the first module is further configured to: write the data in the temporary memory cache area required to be written to the platter to the platter through the available storage space of the SCM.

In some embodiments, the first module is further configured to: write the original track data retrieved from the platter according to the random write instruction to the temporary memory cache area through the available storage space of the SCM.

In some embodiments, the third module is further configured to: monitor the occupied capacity of the temporary memory cache area. Correspondingly, the first module is also configured to: when receiving a new random write instruction and random write data from the host device and the current occupied capacity of the temporary memory cache area is not less than a second capacity threshold, perform the data buffering operation and the data integration operation in the hard drive temporary cache area.

In some embodiments, after performing the data buffering operation and the data integration operation in the hard drive temporary cache area, the second module is further configured to: when performing track rewriting on the platter, cache track rewriting temporary data to the hard drive temporary cache area and write the data in the hard drive temporary cache area required to be written to the platter to the platter.

In some embodiments, the first module is further configured to: when receiving a new random write instruction and random write data from the host device and the current occupied capacity of the temporary memory cache area is less than the second capacity threshold, instruct the host device to write the random write data associated with the random write instruction in the host memory to the temporary memory cache area; perform the data buffering operation and the data integration operation in the temporary memory cache area. Correspondingly, the second module is also configured to: when performing track rewriting on the platter, cache track rewriting temporary data to the temporary memory cache area; write the data in the temporary memory cache area required to be written to the platter to the platter through the available storage space of the SCM.

In some embodiments, the third module is further configured to: request memory usage information from the host device; determine whether a preset application condition is met based on the memory usage information; if the preset application condition is met, request an idle memory space from the host device to be used as a temporary memory cache area.

In some embodiments, the third module is further configured to: after requesting idle memory space from the host device to be used as a temporary memory cache area, measure the duration during which the occupied capacity of the SCM is less than the first capacity threshold; if the measured duration exceeds a preset duration threshold, release the temporary memory cache area.

In some embodiments, the third module is further configured to: request memory usage information from the host device; determine whether a preset release condition is met based on the memory usage information; if the preset release condition is met, release the temporary memory cache area.

In some embodiments, the first module is further configured to: monitor the occupied capacity of the SCM; when receiving a new random write instruction and random write data from the host device and the current occupied capacity of the SCM is not less than a third preset capacity threshold, perform the data buffering operation and the data integration operation in the hard drive temporary cache area. Correspondingly, the second module is also configured to: when performing track rewriting on the platter, cache track rewriting temporary data to the hard drive temporary cache area and write the data in the hard drive temporary cache area required to be written to the platter to the platter.

In some embodiments, the first module is further configured to: when the current occupied capacity of the SCM is less than the third preset capacity threshold, perform the data buffering operation and the data integration operation in the SCM.

Another aspect of the present application also provides an SMR hard drive. The SMR hard drive includes a main controller, a storage class memory (SCM), and a platter.

Specifically, the main controller is configured to perform a data buffering operation and a data integration operation in the SCM in response to receiving a random write instruction and random write data sent from a host device, and to cache track rewriting temporary data to the SCM when performing track rewriting on the platter.

For example, as shown in FIG. 11, the platter storage area of the SMR hard drive stores the aforementioned platter, the SCM is divided into a cache area and a firmware storage area, and the main controller is a main control chip.

Specifically, the models of the main control chip include but are not limited to WD70C22, 8816522, Agere c8-c1, UAB-M3059-T, and SAB-M3054. The models of the SMR hard drive include but are not limited to MD07ACA, MD04, DT02, and WD20EZAZ. The SCM is a type of memory with high-speed read/write characteristics and non-volatility. The types of SCM media include but are not limited to PCM (Phase-change memory), ReRAM (Resistive random-access memory), MRAM (Magnetic Random Access Memory), and NRAM (Nantero's CNT Random Access Memory). The current maximum storage capacity of commercially available SCM can reach 64 GB, and theoretically, it can be as high as several hundred GB. It is evident that the storage capacity of SCM far exceeds that of DRAM (typically 1-16 GB). Therefore, the new cache mode of using SCM to replace the traditional DRAM in SMR hard drives has more advantages compared to the traditional DRAM+MC cache mode. The SMR hard drive can effectively avoid severe performance degradation when facing a large number of random write I/Os. Additionally, SCM has non-volatile characteristics, allowing it to preserve cached data not yet written to the hard drive platter in the event of an abnormal power failure, thereby avoiding the risk of data loss.

In some embodiments, the SCM includes a first firmware storage area, which is used to store the host memory borrowing firmware.

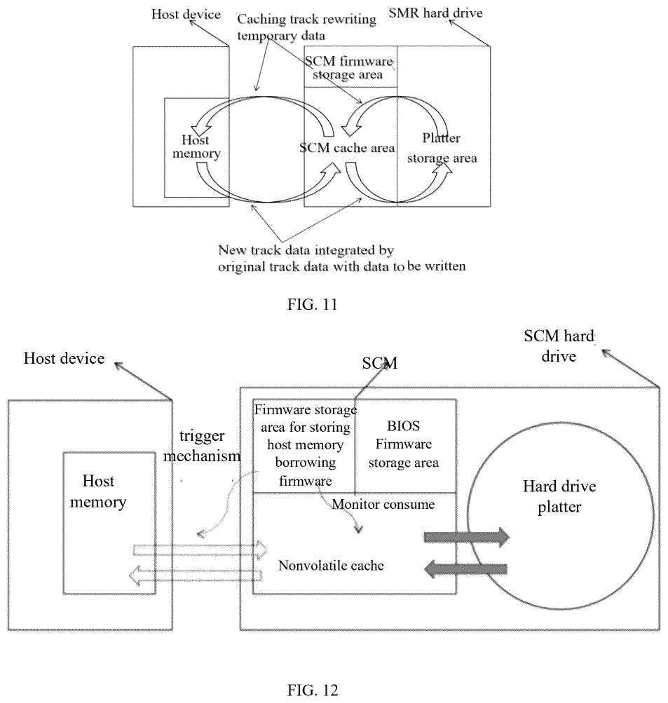

For example, as shown in FIG. 12, the host memory borrowing mechanism-related component storage area is the aforementioned first firmware storage area of the SCM, used to store the host memory borrowing firmware. The main controller of the SMR is the main control chip. When executing the host memory borrowing firmware, the main control chip implements the following random write instruction processing method.

Specifically, the methods that the main control chip can implement when executing the host memory borrowing firmware include: the main control chip monitors the occupied capacity of the SCM. When the occupied capacity of the SCM is not less than the first capacity threshold, the main control chip checks whether a temporary memory cache area is set in the host memory of the host device. Here, the first capacity threshold is less than the total storage capacity of the SCM. When it is detected that no temporary memory cache area is set in the host memory of the host device, the main control chip requests idle memory space from the host device as a temporary memory cache area, where the temporary memory cache area is located in the host memory. Then, after requesting idle memory space from the host device as a temporary memory cache area, the method further includes: when the main control chip receives a new random write instruction and random write data from the host device and the current occupied capacity of the SCM is not less than the first capacity threshold, the main control chip performs a data buffering operation and a data integration operation in the temporary memory cache area.

The methods that can also be implemented include: the main control chip first requests memory usage information from the host device and determines whether a preset application condition is met based on the memory usage information. When the preset application condition is met, the main control chip requests idle memory space from the host device as a temporary memory cache area.

The methods that can also be implemented include: after requesting idle memory space from the host device as a temporary memory cache area, the main control chip measures the duration during which the occupied capacity of the SCM is less than the first capacity threshold. When the measured duration exceeds a preset duration threshold, the main control chip releases the temporary memory cache area. Alternatively, the main control chip requests memory usage information from the host device and determines whether a preset release condition is met based on the memory usage information. When the preset release condition is met, the main control chip releases the temporary memory cache area.

Through the above methods, temporary borrowing of host memory is achieved, and the host memory borrowing firmware is used to request a temporary memory cache area from the host memory, expanding the storage capacity of the SCM cache area.

In some embodiments, the SCM includes a second firmware storage area, which is used to store the BIOS (Basic Input Output System).

For example, as shown in FIG. 12, the BIOS firmware storage area is the aforementioned second firmware storage area, used to store the BIOS (Basic Input Output System). By using SCM to replace the traditional DRAM+MC in SMR hard drives as a new cache mode for SMR hard drives, the SCM can also replace the traditional NOR Flash chip on the SMR hard drive circuit board used to store the BIOS, saving space on the SMR hard drive circuit board and reducing the production and manufacturing costs of SMR hard drives.

Another aspect of the present application also provides a computer device, including a host device and the aforementioned SMR hard drive.

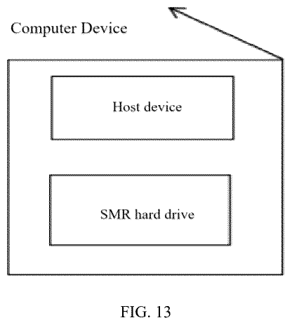

For example, as shown in FIG. 13, the computer device includes a host device and the aforementioned SMR hard drive. The computer device equipped with the SMR hard drive can effectively avoid severe performance degradation when facing a large number of random write I/Os. Additionally, since the SCM inside the SMR hard drive has non-volatile characteristics, the SCM can preserve cached data not yet written to the hard drive platter in the event of an abnormal power failure of the computer device, thereby avoiding the risk of data loss.

The technical features of the above embodiments can be combined arbitrarily. To keep the description concise, not all possible combinations of the technical features in the above embodiments are described. However, as long as there is no contradiction in the combination of these technical features, they should be considered within the scope of this specification.

The above embodiments only express several implementations of this application. The description is relatively specific and detailed, but it should not be understood as limiting the scope of the patent. It should be noted that for those of ordinary skill in the art, without departing from the concept of this application, several modifications and improvements can be made, all of which fall within the protection scope of this application. Therefore, the protection scope of this application patent should be subject to the appended claims.

1. A random write instruction processing method, applied to a main controller in a shingled magnetic recording SMR hard drive that further comprises a storage class memory SCM and a platter, the SCM being a cache area of the SMR hard drive, the method comprising:
in response to receiving a random write instruction and random write data sent from a host device, performing a data buffering operation and a data integration operation in the SCM, and caching track rewriting temporary data to the SCM when performing track rewriting on the platter;
the method further comprises:
monitoring occupied capacity of the SCM;
in response to the occupied capacity of the SCM being not less than a first capacity threshold, detecting whether a temporary memory cache area is provided in a memory of the host device, the first capacity threshold being less than a total storage capacity of the SCM; and
in response to detecting that no temporary memory cache area is provided in the memory of the host device, requesting an idle memory space from the host device to be used as the temporary memory cache area.

2. The method according to claim 1, wherein the data buffering operation is used for organizing the random write data into sequential write data;
the data integration operation is used for integrating original track data retrieved from the platter according to the random write instruction with new data corresponding to the data integration operation to form new track data.

3. (canceled)

4. The method according to claim 1, further comprising:
in response to the occupied capacity of the SCM being less than the first capacity threshold, performing a data buffering operation and a data integration operation in the SCM, and caching track rewriting temporary data to the SCM when performing track rewriting on the platter.

5. The method according to claim 1, wherein after requesting the idle memory space from the host device to be used as the temporary memory cache area, the method further comprises:
in response to receiving a new random write instruction sent from the host device and the current occupied capacity of the SCM being not less than the first capacity threshold, instructing the host device to write the random write data associated with the random write instruction in the memory of the host device to the temporary memory cache area; and
performing the data buffering operation and the data integration operation in the temporary memory cache area, and caching the track rewriting temporary data to the temporary memory cache area when performing track rewriting on the platter.

6. The method according to claim 5, further comprising:
writing data in the temporary memory cache area required to be written to the platter to the platter through an available storage space in the SCM.

7. The method according to claim 6, further comprising:
writing the original track data retrieved from the platter according to the random write instruction to the temporary memory cache area through the available storage space in the SCM.

8. The method according to claim 1, wherein the platter comprises a hard drive temporary cache area, the method further comprises:
monitoring the occupied capacity of the temporary memory cache area; and
in response to receiving a new random write instruction and random write data sent from the host device and the current occupied capacity of the temporary memory cache area being not less than a second capacity threshold, performing the data buffering operation and the data integration operation in the hard drive temporary cache area, wherein the second capacity threshold is not greater than the total storage capacity of the temporary memory cache area.

9. The method according to claim 8, wherein after performing the data buffering operation and the data integration operation in the hard drive temporary cache area, the method further comprises:
when performing track rewriting on the platter, caching the track rewriting temporary data to the hard drive temporary cache area, and writing data in the hard drive temporary cache area required to be written to the platter to the platter.

10. The method according to claim 9, further comprising:
in response to receiving a new random write instruction and random write data sent from the host device and the current occupied capacity of the temporary memory cache area being less than the second capacity threshold, instructing the host device to write the random write data associated with the random write instruction in the memory of the host device to the temporary memory cache area;
performing the data buffering operation and the data integration operation in the temporary memory cache area, and caching the track rewriting temporary data to the temporary memory cache area when performing track rewriting on the platter; and
writing the data in the temporary memory cache area required to be written to the platter to the platter through the available storage space in the SCM.

11. The method according to claim 1, wherein the requesting an idle memory space from the host device to be used as a temporary memory cache area comprises:
requesting memory usage information from the host device;
determining whether a preset application condition is met based on the memory usage information; and
in response to the preset application condition being met, requesting the idle memory space from the host device to be used as the temporary memory cache area.

12. The method according to claim 1, further comprising:
after requesting the idle memory space from the host device to be used as the temporary memory cache area, timing a duration for which the occupied capacity of the SCM is less than the first capacity threshold, and in response to the timed duration exceeding a preset duration threshold, releasing the temporary memory cache area.

13. The method according to claim 1, further comprising:
requesting memory usage information from the host device, determining whether a preset release condition is met based on the memory usage information, and in response to the preset release condition being met, releasing the temporary memory cache area.

14. The method according to claim 1, wherein the platter comprises a hard drive temporary cache area, the method further comprises:
monitoring the occupied capacity of the SCM;
in response to receiving a new random write instruction and random write data sent from the host device and the current occupied capacity of the SCM being not less than a third preset capacity threshold, performing the data buffering operation and the data integration operation in the hard drive temporary cache area, wherein the third preset capacity threshold is less than the total storage capacity of the SCM; and
when performing track rewriting on the platter, caching the track rewriting temporary data to the hard drive temporary cache area, and writing the data in the hard drive temporary cache area required to be written to the platter to the platter.

15. The method according to claim 14, further comprising:
in response to the current occupied capacity of the SCM being less than the third preset capacity threshold, performing the data buffering operation and the data integration operation in the SCM.

16. A random write instruction processing device, located in a shingled magnetic recording SMR hard drive that further comprises a storage class memory SCM and a platter, the SCM being a cache area of the SMR hard drive, the random write instruction processing device comprises:
first module, configured to
perform a data buffering operation and a data integration operation in the SCM in response to receiving a random write instruction and random write data sent from a host device; and
a second module, configured to cache track rewriting temporary data to the SCM when performing track rewriting on the platter;
the device is further configured to:
monitor occupied capacity of the SCM;
in response to the occupied capacity of the SCM being not less than a first capacity threshold, detecting whether a temporary memory cache area is provided in a memory of the host device, the first capacity threshold being less than a total storage capacity of the SCM; and
in response to detecting that no temporary memory cache area is provided in the memory of the host device, requesting an idle memory space from the host device to be used as the temporary memory cache area.

17. A shingled magnetic recording SMR hard drive, comprising a main controller, a storage class memory SCM, and a platter, the SCM being a cache area of the SMR hard drive,
wherein the main controller is configured to execute operations of:
monitoring occupied capacity of the SCM;
in response to the occupied capacity of the SCM being not less than a first capacity threshold, detecting whether a temporary memory cache area is provided in a memory of the host device, the first capacity threshold being less than a total storage capacity of the SCM; and
in response to detecting that no temporary memory cache area is provided in the memory of the host device, requesting an idle memory space from the host device to be used as the temporary memory cache area.

18. The SMR hard drive according to claim 17, wherein the SCM comprises a first firmware storage area for storing host memory borrowing firmware.

19. The SMR hard drive according to claim 17, wherein the SCM comprises a second firmware storage area for storing BIOS that is a basic input/output system.

20. A computer device, comprising a host device and the SMR hard drive according to claim 17.

21. The random write instruction processing device according to claim 16, wherein the data buffering operation is used for organizing the random write data into sequential write data;
the data integration operation is used for integrating original track data retrieved from the platter according to the random write instruction with new data corresponding to the data integration operation to form new track data.
